(19) United States
(12) Patent Application Publication
(10) Pub. No.: US 2025/0289497 A1
(43) Pub. Date: Sep. 18, 2025

(54) VEHICLE DRIVING ASSISTANCE DEVICE, VEHICLE DRIVING ASSISTANCE METHOD, AND STORAGE MEDIUM STORING VEHICLE DRIVING ASSISTANCE PROGRAM

(71) Applicant: TOYOTA JIDOSHA KABUSHIKI KAISHA, Toyota-shi (JP)

(72) Inventors: Satoshi Handa, Kariya-shi (JP); Shusaku Sugamoto, Toyota-shi (JP); Shintaro Saigo, Nisshin-shi (JP); Kentaro Hamada, Nagoya-shi (JP)

(73) Assignee: TOYOTA JIDOSHA KABUSHIKI KAISHA, Toyota-shi (JP)

(21) Appl. No.: 19/073,590

(22) Filed: Mar. 7, 2025

(30) Foreign Application Priority Data
Mar. 18, 2024 (JP) 2024-042727

(51) Int. Cl. B62D 15/02; B60W 30/12

(52) U.S. Cl. CPC B62D 15/025; B60W 30/12; B60W 2540/18; B60W 2710/202

(57) ABSTRACT

A vehicle driving assistance device executes sudden decrease prevention control when actually applied torque that is steering assistance torque applied to steering operation at a time point at which lane boundaries become unrecognizable is larger than zero. The sudden decrease prevention control is control of decreasing the actually applied torque in steps of a predetermined sudden decrease prevention value per unit time from the actually applied torque at the time point at which the lane boundaries become unrecognizable or control of applying to the steering operation, the steering assistance torque set using as a limit steering angle, an angle that is increased in steps of a predetermined sudden decrease prevention angle per unit time from the limit steering angle set by steering assistance control at the time point at which the lane boundaries become unrecognizable.

### CROSS-REFERENCE TO RELATED APPLICATION

This application claims priority to Japanese Patent Application No. 2024-042727 filed on Mar. 18, 2024, incorporated herein by reference in its entirety.

### BACKGROUND

### 1. Technical Field

The present disclosure relates to a vehicle driving assistance device, a vehicle driving assistance method, and a storage medium storing a vehicle driving assistance program.

### 2. Description of Related Art

A patent application for a vehicle driving assistance device that executes steering assistance control of applying steering assistance torque to steering operation to be performed by an operator of an own vehicle to assist the steering operation, the steering assistance torque acting against the steering operation, has been filed (see, for example, Japanese Patent Application No. 2023-61204).

### SUMMARY

In the above-described vehicle driving assistance device in the related art, when the steering assistance control is stopped, the steering assistance torque applied to the steering operation suddenly becomes zero, and thus, there is a possibility that a feeling of strangeness may be provided to the operator of the own vehicle.

An object of the present disclosure is to provide a vehicle driving assistance device capable of preventing a feeling of strangeness to be provided to an operator of an own vehicle when steering assistance control is stopped, a vehicle driving assistance method, and a storage medium storing a vehicle driving assistance program.

A vehicle driving assistance device according to the present disclosure includes a control device that executes steering assistance control of applying steering assistance torque to steering operation to be performed by an operator of an own vehicle to assist the steering operation, the steering assistance torque acting against the steering operation. The control device is configured to execute the steering assistance control when lane boundaries that are boundaries defining a lane on which the own vehicle is traveling is recognizable, and stop the steering assistance control when the lane boundaries become unrecognizable. The steering assistance control is control of setting a limit steering angle based on a position of the own vehicle with respect to the lane boundaries and, when an actual steering angle of the own vehicle is larger than the limit steering angle, applying to the steering operation, the steering assistance torque at a value set based on a difference between the limit steering angle and the actual steering angle. Further, the control device is configured to execute sudden decrease prevention control when actually applied torque that is the steering assistance torque applied to the steering operation at a time point at which the lane boundaries become unrecognizable is larger than zero. The sudden decrease prevention control is control of decreasing the actually applied torque in steps of a predetermined sudden decrease prevention value per unit time from the actually applied torque at the time point at which the lane boundaries become unrecognizable or control of applying to the steering operation, the steering assistance torque set using as the limit steering angle, an angle that is increased in steps of a predetermined sudden decrease prevention angle per unit time from the limit steering angle set by the steering assistance control at the time point at which the lane boundaries become unrecognizable.

According to the vehicle driving assistance device according to the present disclosure, the sudden decrease prevention control is executed when the steering assistance control is stopped. When such sudden decrease prevention control is not executed, the steering assistance torque applied to the steering operation suddenly becomes zero, and thus, there is a possibility that a feeling of strangeness may be provided to the operator of the own vehicle. However, according to the vehicle driving assistance device according to the present disclosure, when the steering assistance control is stopped, the sudden decrease prevention control is executed, and the steering assistance torque to be applied to the steering operation is gradually decreased. This makes it possible to prevent a feeling of strangeness to be provided to the operator of the own vehicle when the steering assistance control is stopped.

Note that in the vehicle driving assistance device according to the present disclosure, the control device can be configured to execute the steering assistance control after executing sudden increase prevention control when the steering assistance torque set by the steering assistance control at a time point at which the lane boundaries become recognizable after the lane boundaries become unrecognizable is larger than the actually applied torque at the time point. Further, in this case, the sudden increase prevention control is control of increasing the actually applied torque in steps of a predetermined sudden increase prevention value per unit time or control of applying to the steering operation, the steering assistance torque set using as the limit steering angle, an angle that is decreased in steps of a predetermined sudden increase prevention angle per unit time from the actual steering angle at the time point at which the lane boundaries become recognizable.

When the lane boundaries become recognizable after the lane boundaries become unrecognizable, the steering assistance control is executed after the sudden increase prevention control is executed. When such sudden increase prevention control is not executed, relatively large steering assistance torque is suddenly applied to the steering operation, and thus, there is a possibility that a feeling of strangeness may be provided to the operator of the own vehicle. However, according to the vehicle driving assistance device according to the present disclosure, before the steering assistance control is started, the sudden increase prevention control is executed, and the steering assistance torque to be applied to the steering operation is gradually increased. This makes it possible to prevent a feeling of strangeness to be provided to the operator of the own vehicle when the steering assistance control is started.

Further, a vehicle driving assistance method according to the present disclosure is a method of executing steering assistance control of applying steering assistance torque to steering operation to be performed by an operator of an own vehicle to assist the steering operation, the steering assistance torque acting against the steering operation. The vehicle driving assistance method according to the present disclosure includes executing the steering assistance control when lane boundaries that are boundaries defining a lane on which the own vehicle is traveling is recognizable, and stopping the steering assistance control when the lane boundaries become unrecognizable. The steering assistance control is control of setting a limit steering angle based on a position of the own vehicle with respect to the lane boundaries and, when an actual steering angle of the own vehicle is larger than the limit steering angle, applying to the steering operation, the steering assistance torque at a value set based on a difference between the limit steering angle and the actual steering angle. Further, the vehicle driving assistance method according to the present disclosure further includes executing sudden decrease prevention control when actually applied torque that is the steering assistance torque applied to the steering operation at a time point at which the lane boundaries become unrecognizable is larger than zero. The sudden decrease prevention control is control of decreasing the actually applied torque in steps of a predetermined sudden decrease prevention value per unit time from the actually applied torque at the time point at which the lane boundaries become unrecognizable or control of applying to the steering operation, the steering assistance torque set using as the limit steering angle, an angle that is increased in steps of a predetermined sudden decrease prevention angle per unit time from the limit steering angle set by the steering assistance control at the time point at which the lane boundaries become unrecognizable.

According to the vehicle driving assistance method according to the present disclosure, it is possible to prevent a feeling of strangeness to be provided to a driver when the steering assistance control is stopped.

Further, a storage medium storing a vehicle driving assistance program according to the present disclosure is a storage medium storing a program of executing steering assistance control of applying steering assistance torque to steering operation to be performed by an operator of an own vehicle to assist the steering operation, the steering assistance torque acting against the steering operation. The vehicle driving assistance program according to the present disclosure is configured to execute the steering assistance control when lane boundaries that are boundaries defining a lane on which the own vehicle is traveling is recognizable, and stop the steering assistance control when the lane boundaries become unrecognizable. The steering assistance control is control of setting a limit steering angle based on a position of the own vehicle with respect to the lane boundaries and, when an actual steering angle of the own vehicle is larger than the limit steering angle, applying to the steering operation, the steering assistance torque at a value set based on a difference between the limit steering angle and the actual steering angle. Further, the vehicle driving assistance program according to the present disclosure is configured to execute sudden decrease prevention control when actually applied torque that is the steering assistance torque applied to the steering operation at a time point at which the lane boundaries become unrecognizable is larger than zero. The sudden decrease prevention control is control of decreasing the actually applied torque in steps of a predetermined sudden decrease prevention value per unit time from the actually applied torque at the time point at which the lane boundaries become unrecognizable or control of applying to the steering operation, the steering assistance torque set using as the limit steering angle, an angle that is increased in steps of a predetermined sudden decrease prevention angle per unit time from the limit steering angle set by the steering assistance control at the time point at which the lane boundaries become unrecognizable.

According to the vehicle driving assistance program according to the present disclosure, it is possible to prevent a feeling of strangeness to be provided to the driver when the steering assistance control is stopped.

Components of the present disclosure are not limited to those in an embodiment of the present disclosure which will be described later with reference to the drawings. Other objects, other features and accompanying advantages of the present disclosure will be easily understood from description of the embodiment of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating a vehicle driving assistance device according to an embodiment of the present disclosure;

FIG. 2 is a view illustrating lane boundaries;

FIG. 3 is a flowchart indicating a routine to be executed by the vehicle driving assistance device according to the embodiment of the present disclosure;

FIG. 4 is a view indicating transition of actually applied torque to be implemented by the vehicle driving assistance device according to the present disclosure when the lane boundaries are recognized;

FIG. 5 is a view indicating one case of the transition of the actually applied torque to be implemented by the vehicle driving assistance device according to the present disclosure when the lane boundaries become unrecognized; and

FIG. 6 is a view indicating another case of the transition of the actually applied torque to be implemented by the vehicle driving assistance device according to the present disclosure when the lane boundaries become unrecognized.

### DETAILED DESCRIPTION OF EMBODIMENTS

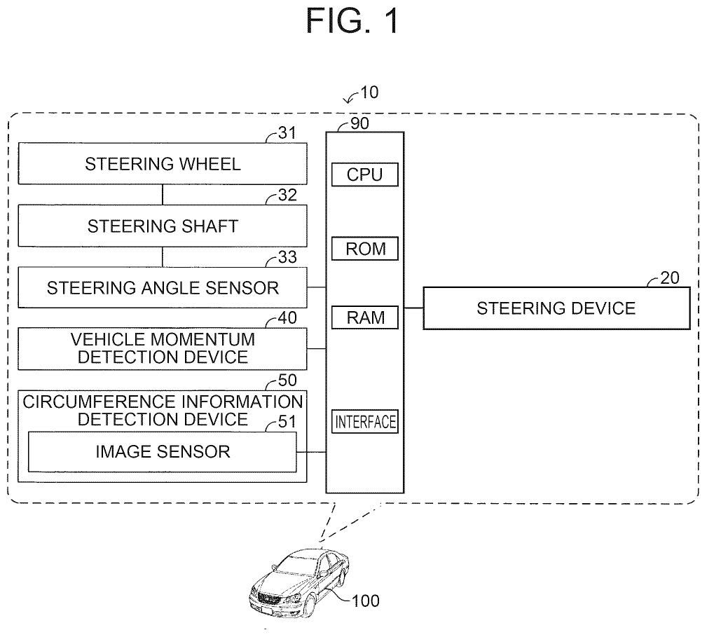

A vehicle driving assistance device, a vehicle driving assistance method, and a vehicle driving assistance program according to an embodiment of the present disclosure will be described below with reference to the drawings. FIG. 1 illustrates a vehicle driving assistance device 10 according to the embodiment of the present disclosure. The vehicle driving assistance device 10 is mounted on an own vehicle 100. The vehicle driving assistance device 10 will be described below using an example of a case where an operator of the own vehicle 100 is a person who gets on the own vehicle 100 and drives the own vehicle 100 (that is, a driver of the own vehicle 100).

However, the operator of the own vehicle 100 may be a person who remotely drives the own vehicle 100 without getting on the own vehicle 100 (that is, a remote operator of the own vehicle 100). When the operator of the own vehicle 100 is a remote operator, the vehicle driving assistance device 10 is mounted on each of the own vehicle 100 and remote operation equipment provided outside the own vehicle 100 to remotely drive the own vehicle 100, and functions of the vehicle driving assistance device 10 to be described below are shared and performed by the vehicle driving assistance device 10 mounted on the own vehicle 100 and the vehicle driving assistance device 10 mounted on the remote operation equipment.

As illustrated in FIG. 1, the vehicle driving assistance device 10 includes an electronic control unit (ECU) 90 as a control device. The ECU 90 includes a microcomputer as a main component. The microcomputer includes a storage medium such as a CPU, a ROM, a RAM and a non-volatile memory, an interface, and the like. The CPU implements various kinds of functions by executing instructions, or programs or routines stored in the storage medium. Particularly, in the present example, the vehicle driving assistance device 10 stores programs to implement various kinds of control to be executed by the vehicle driving assistance device 10 in the storage medium.

Note that while in the present example, the vehicle driving assistance device 10 includes only one ECU 90, the vehicle driving assistance device 10 may include a plurality of ECUs and may be configured such that the respective ECUs share and perform functions of the vehicle driving assistance device 10 to be described below.

Further, the vehicle driving assistance device 10 may be configured to be able to update the programs stored in the storage medium through wireless communication (for example, Internet communication) with external devices.

On the own vehicle 100, a steering device 20, a steering wheel 31, a steering shaft 32, a steering angle sensor 33, a vehicle momentum detection device 40, and a circumference information detection device 50 are mounted. The circumference information detection device 50 is a device that detects information regarding a circumference of the own vehicle 100, and in the present example, an image sensor 51 is provided. The steering device 20, the steering angle sensor 33, the vehicle momentum detection device 40 and the image sensor 51 are respectively electrically connected to the ECU 90.

The vehicle driving assistance device 10 controls steering assistance torque to be applied to steering operation to be performed by a driver of the own vehicle 100 by controlling actuation of the steering device 20, the steering assistance torque acting against the steering operation. The steering operation is operation of the driver turning the steering wheel 31 to steer the own vehicle 100.

Further, the vehicle driving assistance device 10 acquires a rotation angle of the steering shaft 32 with respect to a neutral position as an actual steering angle δa by the steering angle sensor 33. Still further, the vehicle driving assistance device 10 also acquires steering angle information such as steering angular velocity based on the actual steering angle δa.

Further, the vehicle driving assistance device 10 acquires information (vehicle state information) related to momentum of the own vehicle 100 by the vehicle momentum detection device 40. The momentum of the own vehicle 100 includes, for example, traveling speed, lateral velocity, lateral acceleration, longitudinal acceleration, a yaw rate, and the like, of the own vehicle 100.

Further, the image sensor 51 is a sensor that acquires an image of the circumference of the own vehicle 100 and is, for example, a camera. The vehicle driving assistance device 10 captures an image of the circumference of the own vehicle 100 by the image sensor 51 and acquires information (image information) regarding the captured image as circumference information IS. Still further, the vehicle driving assistance device 10 acquires information regarding lane boundaries TB which will be described later and lane boundary information such as a positional relationship between the own vehicle 100 and each of the lane boundaries TB based on the circumference information IS. In particular, the vehicle driving assistance device 10 recognizes the lane boundaries TB based on the circumference information IS.

### Actuation of Vehicle Driving Assistance Device

Actuation of the vehicle driving assistance device 10 will be described next. The vehicle driving assistance device 10 executes steering assistance control when the lane boundaries TB are recognizable. In particular, in the present example, the vehicle driving assistance device 10 executes the steering assistance control when both a left lane boundary TB_L and a right lane boundary TB_R are recognizable. However, the vehicle driving assistance device 10 may be configured to execute the steering assistance control when at least one of the left lane boundary TB_L or the right lane boundary TB_R is recognizable.

The steering assistance control is control of applying steering assistance torque to steering operation to be performed by the driver of the own vehicle 100 to assist the steering operation, the steering assistance torque acting against the steering operation.

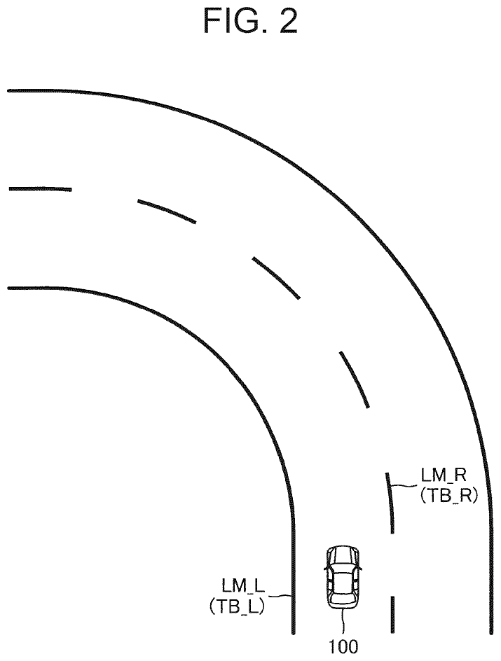

Further, the lane boundaries TB are boundaries that define a lane on which the own vehicle 100 is traveling. As illustrated in FIG. 2, the lane boundaries TB are, for example, a left compartment line LM_L and a right compartment line LM_R which define the lane on which the own vehicle 100 is traveling and which are white lines, or the like. In particular, the left lane boundary TB_L is, for example, the left compartment line LM_L illustrated in FIG. 2, and the right lane boundary TB_R is, for example, the right compartment line LM_R illustrated in FIG. 2. Further, the lane boundaries TB may be a side wall surface of the other vehicle on the own vehicle 100 side when the other vehicle such as a track that is traveling side-by-side with the own vehicle 100 exists on a lane adjacent to the lane on which the own vehicle 100 is traveling.

The vehicle driving assistance device 10 sets a left limit steering angle δlim_L and a right limit steering angle δlim_R as a limit steering angle δlim based on the vehicle state information, the lane boundary information, and the like, when the steering assistance control is started.

Further, when an actual steering angle δa when the driver operates to turn the steering wheel 31 counterclockwise is larger than the left limit steering angle δlim_L, the vehicle driving assistance device 10 sets clockwise steering assistance torque TQ at a value that is larger as a difference between the left limit steering angle δlim_L and the actual steering angle δa is larger and applies the clockwise steering assistance torque TQ to the steering operation (more specifically, the steering shaft 32). On the other hand, when the actual steering angle δa when the driver operates to turn the steering wheel 31 clockwise is larger than the right limit steering angle δlim_R, the vehicle driving assistance device 10 sets counterclockwise steering assistance torque TQ that is larger as a difference between the right limit steering angle δlim_R and the actual steering angle δa is larger and applies the counterclockwise steering assistance torque TQ to the steering operation (more specifically, the steering shaft 32).

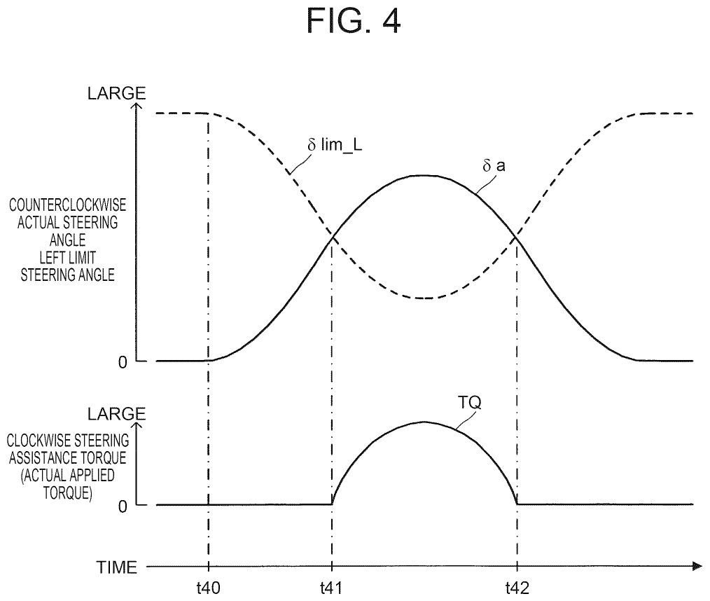

By this means, as indicated in FIG. 4, when the actual steering angle δa when the driver operates to turn the steering wheel 31 counterclockwise from the neutral position is larger than the left limit steering angle δlim_L, the clockwise steering assistance torque TQ is applied to the steering operation. In other words, the clockwise steering assistance torque TQ to be applied to the steering operation becomes larger than zero. On the other hand, when the actual steering angle δa when the driver operates to turn the steering wheel 31 clockwise from the neutral position is larger than the right limit steering angle δlim_R, the counterclockwise steering assistance torque TQ is applied to the steering operation. In other words, the counterclockwise steering assistance torque TQ to be applied to the steering operation becomes larger than zero.

Note that in the example indicated in FIG. 4, the counterclockwise steering operation is started at time t40, and from time t41 to time t42, the actual steering angle δa is larger than the left limit steering angle δlim_L, and thus, the clockwise steering assistance torque TQ to be applied to the steering operation is larger than zero.

In this manner, the vehicle driving assistance device 10 is configured to set the limit steering angle δlim based on the position of the own vehicle 100 with respect to the lane boundaries TB, and, when the actual steering angle δa of the own vehicle 100 is larger than the limit steering angle δlim, apply to the steering operation, the steering assistance torque TQ at a value set based on a difference between the limit steering angle δlim and the actual steering angle δa.

Note that the left limit steering angle δlim_L is set at a value that is smaller as the own vehicle 100 is closer to the left lane boundary TB_L, and the right limit steering angle δlim_R is set at a value that is smaller as the own vehicle 100 is closer to the right lane boundary TB_R. In other words, the left limit steering angle δlim_L is set based on the position of the own vehicle 100 with respect to the left lane boundary TB_L, and the right limit steering angle δlim_R is set based on the position of the own vehicle 100 with respect to the right lane boundary TB_R.

Further, in the present example, the actual steering angle δa is a positive value both when the steering wheel 31 is operated counterclockwise based on the neutral position and when the steering wheel 31 is operated clockwise, and thus, both the left limit steering angle δlim_L and the right limit steering angle δlim_R are set at positive values. Further, the limit steering angle δlim is used to set the steering assistance torque TQ to be applied to the steering operation such that the own vehicle 100 does not cross the lane boundaries TB and can be set using various publicly known methods (for example, a method described in Japanese Patent Application No. 2023-61204).

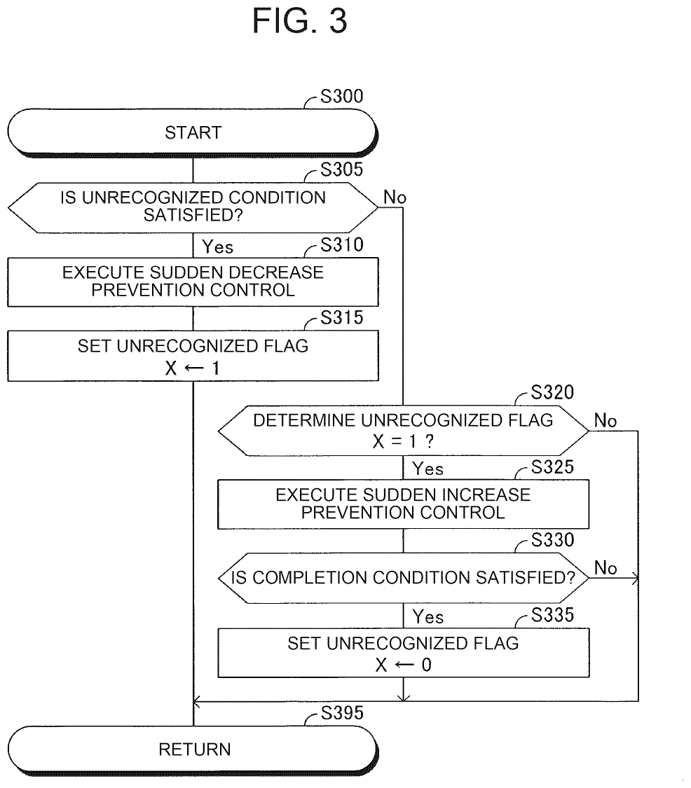

Further, the vehicle driving assistance device 10 executes sudden change prevention control when a predetermined condition is satisfied as a result of the routine indicated in FIG. 3 being executed at predetermined time intervals. The sudden change prevention control is control of preventing sudden change of the steering assistance torque.

When a predetermined timing comes, the vehicle driving assistance device 10 starts processing from step S300 of the routine indicated in FIG. 3, causes the processing to proceed to step S305, and determines whether an unrecognized condition C1 is satisfied. The unrecognized condition C1 is a condition that at least one of the left lane boundary TB_L or the right lane boundary TB_R becomes unrecognized. As a scene in which the unrecognized condition C1 is satisfied, for example, a scene in which the own vehicle 100 is traveling on a road with a sharp curve or a scene in which a compartment line such as a white line is blurred is conceivable. However, even if the own vehicle 100 is not traveling on a straight road, or even if the compartment line is not blurred, the unrecognized condition C1 is sometimes satisfied depending on a direction of the own vehicle 100 with respect to the road, or the like.

When determination of “Yes” is made in step S305, the vehicle driving assistance device 10 causes the processing to proceed to step S310, stops the steering assistance control and executes sudden decrease prevention control of preventing sudden decrease of the steering assistance torque TQ as the sudden change prevention control. In other words, the vehicle driving assistance device 10 is configured to stop the steering assistance control and execute the sudden decrease prevention control when the lane boundaries TB become unrecognizable. Then, the vehicle driving assistance device 10 causes the processing to proceed to step S315 and sets a value of an unrecognized flag X at “1”. Then, the vehicle driving assistance device 10 causes the processing to proceed to step S395 and ends the processing of the present routine once.

The sudden decrease prevention control is (1) control of decreasing actually applied torque TQa in steps of a predetermined value (sudden decrease prevention value TQd) per unit time from the actually applied torque TQa at a time point at which at least one of the left lane boundary TB_L or the right lane boundary TB_R becomes unrecognized (time point of the boundary becoming unrecognized) when steering assistance torque TQ (actually applied torque TQa) actually applied to the steering operation at the time point of the boundary becoming unrecognized is larger than zero or (2) control of applying to the steering operation, the steering assistance torque TQ set using as the limit steering angle δlim, an angle that is increased by a predetermined angle (sudden decrease prevention angle δd) per unit time from the limit steering angle δlim set by the steering assistance control at the time point of the boundary becoming unrecognized.

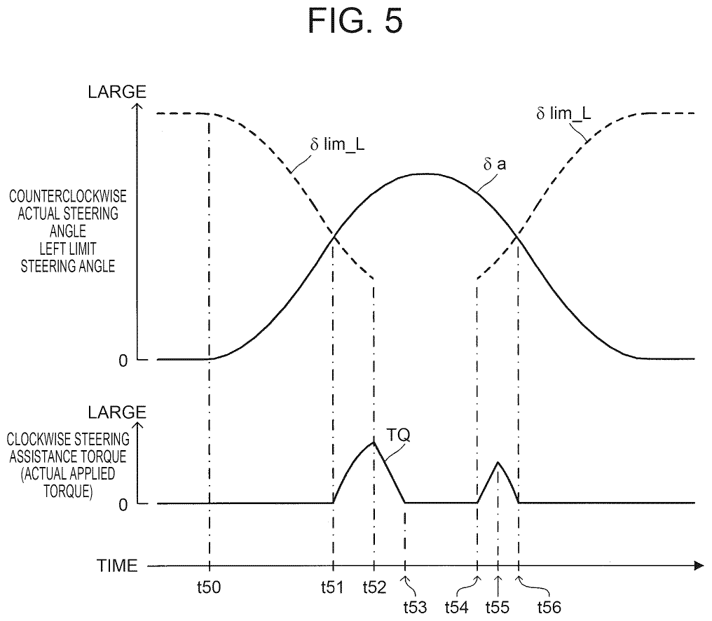

More specifically, as indicated in FIG. 5, the sudden decrease prevention control is control of, when the steering wheel 31 is operated counterclockwise, decreasing the clockwise actually applied torque TQa in steps of a predetermined value (first sudden decrease prevention value TQd_1) per unit time from the clockwise actually applied torque TQa at the time point of the boundary becoming unrecognized when the clockwise actually applied torque TQa at the time point of the boundary becoming unrecognized is larger than zero and, when the steering wheel 31 is operated clockwise, decreasing the counterclockwise actually applied torque TQa in steps of a predetermined value (second sudden decrease prevention value TQd_2) per unit time from the counterclockwise actually applied torque TQa at the time point of the boundary becoming unrecognized when the counterclockwise actually applied torque TQa at the time point of the boundary becoming unrecognized is larger than zero.

Note that in the example indicated in FIG. 5, the counterclockwise steering operation is started at time t50, the actual steering angle δa becomes larger than the left limit steering angle δlim_L at time t51, then, the left lane boundary TB_L becomes unrecognized at time t52, and the clockwise actually applied torque TQa is gradually decreased by the sudden decrease prevention control from time t52 to time t53. Further, the clockwise actually applied torque TQa reaches zero at time t53.

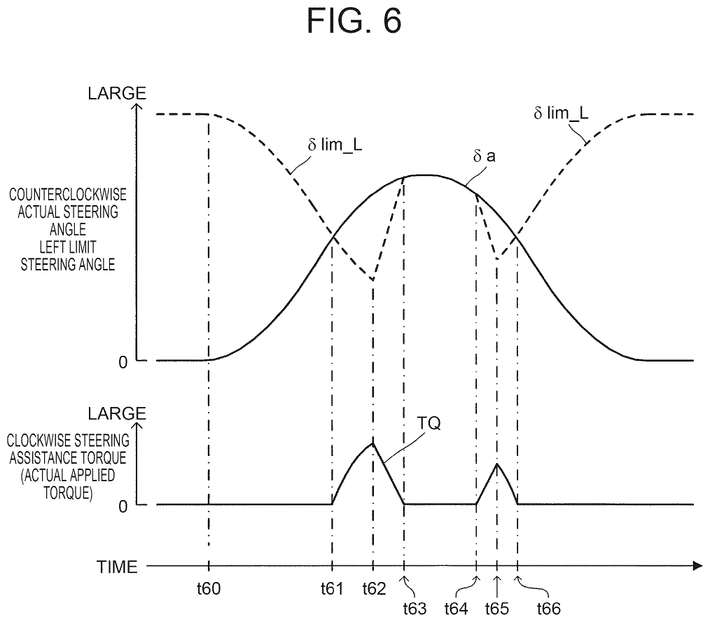

Alternatively, as indicated in FIG. 6, the sudden decrease prevention control is control of, when the steering wheel 31 is operated counterclockwise, applying to the steering operation, the clockwise steering assistance torque TQ set using as the left limit steering angle δlim_L, an angle that is increased in steps of a predetermined angle (first sudden decrease prevention angle δd_1) per unit time from the left limit steering angle δlim_L set by the steering assistance control at the time point of the boundary becoming unrecognized and, when the steering wheel 31 is operated clockwise, applying to the steering operation, the counterclockwise steering assistance torque TQ set using as the right limit steering angle δlim_R, an angle that is increased in steps of a predetermined angle (second sudden decrease prevention angle δd_2) per unit time from the right limit steering angle δlim_R set by the steering assistance control at the time point of the boundary becoming unrecognized.

Note that in the example indicated in FIG. 6, the counterclockwise steering operation is started at time t60, the actual steering angle δa becomes larger than the left limit steering angle δlim_L at time t61, then, the left lane boundary TB_L becomes unrecognized at time t62, and the left limit steering angle δlim_L is gradually increased by the sudden decrease prevention control, thereby, the clockwise actually applied torque TQa is gradually decreased from time t52 to time t53. Further, at time t63, the left limit steering angle δlim_L set by the sudden decrease prevention control reaches the actual steering angle δa, thereby, the clockwise actually applied torque TQa reaches zero.

Note that each of the first sudden decrease prevention value TQd_1 and the second sudden decrease prevention value TQd_2 may be a fixed value or may be, for example, set in accordance with the following equation 1 and equation 2.

$$TQd\_ 1 = TQa\_R \_lost / Td \qquad ( 1 )$$

$$TQd\_ 2 = TQa\_L \_lost / Td \qquad ( 2 )$$

In equation 1, “TQa_R_lost” is the clockwise actually applied torque TQa at the time point of the boundary becoming unrecognized, and in equation 2, “TQa_L_lost” is the counterclockwise actually applied torque TQa at the time point of the boundary becoming unrecognized. Further, in equation 1 and equation 2, “Td” is a period (target transition period) set in advance as a target value of a period from when the sudden decrease prevention control is started until the actually applied torque TQa reaches zero.

Further, when the sudden decrease prevention control is control of applying to the steering operation, the steering assistance torque TQ set using as the limit steering angle δlim, an angle that is increased in steps of the sudden decrease prevention angle δd per unit time from the limit steering angle δlim set by the steering assistance control at the time point of the boundary becoming unrecognized, the left limit steering angle δlim_L and the right limit steering angle δlim_R set by the sudden decrease prevention control may be respectively set using the fixed first sudden decrease prevention angle δd_1 and the fixed second sudden decrease prevention angle δd_2, but may be set in accordance with the following equation 3 and equation 4.

$$δlim\_L = α \cdot δlim\_L \_lost + ( 1 - α ) \cdot δ a \qquad ( 3 )$$

$$δlim\_R = α \cdot δlim\_R \_lost + ( 1 - α ) \cdot δ a \qquad ( 4 )$$

Note that in equation 3, “δlim_L_lost” is the left limit steering angle δlim_L set by the steering assistance control at the time point of the boundary becoming unrecognized, and in equation 4, “δlim_R_lost” is the right limit steering angle δlim_R set by the steering assistance control at the time point of the boundary becoming unrecognized. Further, in equation 3 and equation 4, “α” is a coefficient and is acquired in accordance with the following equation 5.

$$α = Tlost / Td \qquad ( 5 )$$

In equation 5, “Tlost” is a period that has elapsed since the start of the sudden decrease prevention control.

Alternatively, the sudden decrease prevention control may be control of setting the steering assistance torque TQ using as the limit steering angle δlim, an angle that is increased in steps of the sudden decrease prevention angle δd per unit time from the limit steering angle δlim set by the steering assistance control at the time point of the boundary becoming unrecognized when the steering assistance torque TQ set by the steering assistance control at the time of the boundary becoming unrecognized is larger than zero, applying the set steering assistance torque TQ to the steering operation when a decrease amount of the actually applied torque TQa per unit time is equal to or less than the sudden decrease prevention value TQd when the set steering assistance torque TQ is applied to the steering operation, and applying to the steering operation, the steering assistance torque TQ at which the decrease amount of the actually applied torque TQa per unit time becomes the sudden decrease prevention value TQd when the decrease amount of the actually applied torque TQa per unit time is larger than the sudden decrease prevention value TQd when the set steering assistance torque TQ is applied to the steering operation.

In this manner, the sudden decrease prevention control is control of decreasing the actually applied torque TQa in steps of a predetermined sudden decrease prevention value TQd per unit time from the actually applied torque TQa at the time point of the boundary becoming unrecognized or control of applying to the steering operation, the steering assistance torque TQ set using as the limit steering angle δlim, an angle that is increased in steps of the sudden decrease prevention angle δd per unit time from the limit steering angle δlim set by the steering assistance control at the time of the boundary becoming unrecognized. Further, the vehicle driving assistance device 10 is configured to execute the sudden decrease prevention control when the actually applied torque TQa at the time point of the boundary becoming unrecognized is larger than zero.

On the other hand, when determination of “No” is made in step S305, the vehicle driving assistance device 10 causes the processing to proceed to step S320 and determines whether a value of the unrecognized flag X is “1”.

When determination of “Yes” is made in step S320, the vehicle driving assistance device 10 causes the processing to proceed to step S325. In other words, the vehicle driving assistance device 10 causes the processing to proceed to step S325 when both the left lane boundary TB_L and the right lane boundary TB_R becomes recognizable after at least one of the left lane boundary TB_L or the right lane boundary TB_R becomes unrecognizable.

When the processing proceeds to step S325, the vehicle driving assistance device 10 ends the sudden decrease prevention control and executes sudden increase prevention control of preventing sudden increase of the steering assistance torque TQ as the sudden change prevention control. Then, the vehicle driving assistance device 10 causes the processing to proceed to step S330.

The sudden increase prevention control is (1) control of increasing the actually applied torque TQa in steps of a predetermined value (sudden increase prevention value TQu) per unit time from the actually applied torque TQa at a time point at which both the left lane boundary TB_L and the right lane boundary TB_R become recognized (time point of the boundaries becoming recognized again) when the steering assistance control TQ set by the steering assistance control at the time point of the boundaries becoming recognized again is larger than the actually applied torque TQa at the time point of the boundaries becoming recognized again, or (2) control of applying to the steering operation, the steering assistance torque TQ set using as the limit steering angle δlim, an angle that is decreased in steps of a predetermined angle (sudden increase prevention angle δu) per unit time from the actual steering angle δa at the time point of the boundaries becoming recognized again.

More specifically, as indicated in FIG. 5, the sudden increase prevention control is control of, when the steering wheel 31 is operated counterclockwise, increasing the clockwise actually applied torque TQa in steps of a predetermined value (first sudden increase prevention value TQu_1) per unit time from the clockwise actually applied torque TQa at the time point of the boundaries becoming recognized again when the clockwise steering assistance torque TQ set by the steering assistance control at the time point of the boundaries becoming recognized again is larger than the clockwise actually applied torque TQa at the time point of the boundaries becoming recognized again, and, when the steering wheel 31 is operated clockwise, increasing the counterclockwise actually applied torque TQa in steps of a predetermined value (second sudden increase prevention value TQu_2) per unit time from the counterclockwise actually applied torque TQa at the time point of the boundaries becoming recognized again when the counterclockwise steering assistance torque TQ set by the steering assistance control at the time point of the boundaries becoming recognized again is larger than the counterclockwise actually applied torque TQa at the time point of the boundaries becoming recognized again.

Note that in the example indicated in FIG. 5, after the left lane boundary TB_L becomes unrecognized at time t52, the left lane boundary TB_L becomes recognized at time t54, and the clockwise actually applied torque TQa is gradually increased by the sudden increase prevention control from time t54 to time t55. Further, at time t55, the clockwise actually applied torque TQa reaches the counterclockwise steering assistance torque TQ set by the steering assistance control, the sudden increase prevention control ends, and the steering assistance control is started.

Alternatively, as indicated in FIG. 6, the sudden increase prevention control is control of, when the steering wheel 31 is operated counterclockwise, applying to the steering operation, the clockwise steering assistance torque TQ set using as the left limit steering angle δlim_L, an angle that is decreased in steps of a predetermined angle (first sudden increase prevention angle δu_1) per unit time from the actual steering angle δa at the time point of the boundaries becoming recognized again, and, when the steering wheel 31 is operated clockwise, applying to the steering operation, the counterclockwise steering assistance torque TQ set using as the right limit steering angle δlim_R, an angle that is decreased in steps of a predetermined value (second sudden increase prevention angle δu_2) per unit time from the actual steering angle δa at the time point of the boundaries becoming recognized again.

Note that in the example indicated in FIG. 6, after the left lane boundary TB_L becomes unrecognized at time t62, the left lane boundary TB_L becomes recognized at time t64, and the left limit steering angle δlim_L is gradually decreased by the sudden increase prevention control, thereby, the clockwise actually applied torque TQa is gradually increased from time t64 to time t65. Further, at time t65, the left limit steering angle δlim_L set by the sudden increase prevention control reaches the left limit steering angle δlim_L set by the steering assistance control, the sudden increase prevention control ends, and the steering assistance control is started.

Note that each of the first sudden increase prevention value TQu_1 and the second sudden increase prevention value TQu_2 may be a fixed value or may be, for example, set in accordance with the following equation 6 and equation 7.

$$TQu\_ 1 = TQa\_R \_req / Tu \qquad \text{(6)}$$

$$TQu\_ 2 = TQa\_L \_req / Tu \qquad ( 7 )$$

In equation 6, “TQa_R_req” is the clockwise actually applied torque TQa at the time point of the boundaries becoming recognized again, and in equation 7, “TQa_L_req” is the counterclockwise actually applied torque TQa at the time point of the boundaries becoming recognized again. Further, in equation 6 and equation 7, “Tu” is a period (target transition period) set in advance as a target value of a period from when the sudden increase prevention control is started until when the actually applied torque TQa reaches the steering assistance torque TQ set by the steering assistance control.

Further, when the sudden increase prevention control is control of applying to the steering operation, the steering assistance torque TQ set using as the limit steering angle δlim, an angle that is decreased in steps of the sudden increase prevention angle δu per unit time from the actual steering angle δa at the time point of the boundaries becoming recognized again, the left limit steering angle δlim_L and the right limit steering angle δlim_R to be set by the sudden increase prevention control may be respectively set using the fixed first sudden increase prevention angle δu_1 and the fixed second sudden increase prevention angle δu_2, but may be set in accordance with the following equation 8 and equation 9.

$$δlim\_L = α \cdot δ a + ( 1 - α ) \cdot δlim\_L \_assist \qquad ( 8 )$$

$$δlim\_R = α \cdot δ a + ( 1 - α ) \cdot δlim\_R \_assist \qquad ( 9 )$$

In equation 8, “δlim_L_assist” is the left limit steering angle δlim_L set by the steering assistance control, and in equation 9, “δlim_R_assist” is the right limit steering angle δlim_R set by the steering assistance control. Further, in equation 8 and equation 9, “α” is a coefficient and is acquired in accordance with the following equation 10.

$$α = Treq / Tu \qquad ( 10 )$$

In equation 10, “Treq” is a period that has elapsed since the start of the sudden increase prevention control.

Alternatively, the sudden increase prevention control may be control of setting the steering assistance torque TQ using as the limit steering angle δlim, an angle that is decreased in steps of the sudden increase prevention angle δu per unit time from the actual steering angle δa at the time point of the boundaries becoming recognized again when the steering assistance torque TQ set by the steering assistance control at the time point of the boundaries becoming recognized again is larger than the actually applied torque TQa at the time point of the boundaries becoming recognized again, applying the set steering assistance torque TQ to the steering operation when an increase amount of the actually applied torque TQa per unit time is equal to or less than the sudden increase prevention value TQu when the set steering assistance torque TQ is applied to the steering operation, and applying to the steering operation, the steering assistance torque TQ at which the increase amount of the actually applied torque TQa per unit time becomes the sudden increase prevention value TQu when the increase amount of the actually applied torque TQa per unit time is larger than the sudden increase prevention value TQu when the set steering assistance torque TQ is applied to the steering operation.

In this manner, the sudden increase prevention control is control of increasing the actually applied torque TQa in steps of a predetermined sudden increase prevention value TQu per unit time or control of applying to the steering operation, the steering assistance torque TQ set using as the limit steering angle δlim, an angle that is decreased in steps of a predetermined sudden increase prevention angle δu per unit time from the actual steering angle δa at the time point at which the lane boundaries TB become recognizable. Further, the vehicle driving assistance device 10 is configured to execute the steering assistance control after executing the sudden increase prevention control when the steering assistance torque TQ set by the steering assistance control at the time point at which the lane boundaries TB become recognizable after the lane boundaries TB become unrecognizable is larger than the actually applied torque TQa at the time point.

When the processing proceeds to step S330, the vehicle driving assistance device 10 determines whether a completion condition C2 is satisfied. The completion condition C2 is a condition that the actually applied torque TQa reaches the steering assistance torque TQ set by the steering assistance control when the actually applied torque TQa is increased in steps of the sudden increase prevention value TQu by the sudden increase prevention control, and is a condition that the limit steering angle δlim set by the sudden increase prevention control reaches the limit steering angle δlim set by the steering assistance control when the steering assistance torque TQ is applied to the steering operation, the steering assistance torque TQ being set using as the limit steering angle δlim, an angle that is decreased by the sudden increase prevention control in steps of the sudden increase prevention angle δu per unit time from the actual steering angle δa at the time point of the boundaries becoming recognized again.

When determination of “Yes” is made in step S330, the vehicle driving assistance device 10 sets a value of the unrecognized flag X at “0”. Then, the vehicle driving assistance device 10 causes the processing to proceed to step S395 and ends the processing of the present routine once. By this means, the sudden increase prevention control ends, and the steering assistance control is started.

Further, when determination of “No” is made in step S320, or when determination of “No” is made in step S330, the vehicle driving assistance device 10 causes the processing to proceed to step S395 and ends the processing of the present routine once.

The actuation of the vehicle driving assistance device 10 has been described above.

According to the vehicle driving assistance device 10, when the steering assistance control is stopped, the sudden decrease prevention control is executed. When such sudden decrease prevention control is not executed, the steering assistance torque TQ to be applied to the steering operation suddenly becomes zero, and thus, there is a possibility that a feeling of strangeness may be provided to the driver. However, according to the vehicle driving assistance device 10, when the steering assistance control is stopped, the sudden decrease prevention control is executed, and the steering assistance torque TQ to be applied to the steering operation is gradually decreased. This makes it possible to prevent a feeling of strangeness to be provided to the driver when the steering assistance control is stopped.

Note that the present disclosure is not limited to the above embodiment, and various modifications can be employed within the scope of the present disclosure.

For example, the present disclosure can be applied to a vehicle capable of traveling by manual driving operation and autonomous driving control. When the present disclosure is applied to the vehicle, the present disclosure is utilized in a scene in which the autonomous driving control is stopped as a result of a predetermined condition such as a condition that a driver himself/herself operates an accelerator pedal being satisfied, and the vehicle is traveling by the manual driving operation.

What is claimed is:

1. A vehicle driving assistance device comprising a control device that executes steering assistance control of applying steering assistance torque to steering operation to be performed by an operator of an own vehicle to assist the steering operation, the steering assistance torque acting against the steering operation,
the control device being configured to:
execute the steering assistance control when lane boundaries that are boundaries defining a lane on which the own vehicle is traveling is recognizable; and
stop the steering assistance control when the lane boundaries become unrecognizable, and
the steering assistance control being control of setting a limit steering angle based on a position of the own vehicle with respect to the lane boundaries and, when an actual steering angle of the own vehicle is larger than the limit steering angle, applying to the steering operation, the steering assistance torque at a value set based on a difference between the limit steering angle and the actual steering angle, wherein:
the control device is configured to execute sudden decrease prevention control when actually applied torque that is the steering assistance torque applied to the steering operation at a time point at which the lane boundaries become unrecognizable is larger than zero, and
the sudden decrease prevention control is control of decreasing the actually applied torque in steps of a predetermined sudden decrease prevention value per unit time from the actually applied torque at the time point at which the lane boundaries become unrecognizable or control of applying to the steering operation, the steering assistance torque set using as the limit steering angle, an angle that is increased in steps of a predetermined sudden decrease prevention angle per unit time from the limit steering angle set by the steering assistance control at the time point at which the lane boundaries become unrecognizable.

2. The vehicle driving assistance device according to claim 1, wherein:
the control device is configured to execute the steering assistance control after executing sudden increase prevention control when the steering assistance torque set by the steering assistance control at a time point at which the lane boundaries become recognizable after the lane boundaries become unrecognizable is larger than the actually applied torque at the time point; and
the sudden increase prevention control is control of increasing the actually applied torque in steps of a predetermined sudden increase prevention value per unit time or control of applying to the steering operation, the steering assistance torque set using as the limit steering angle, an angle that is decreased in steps of a predetermined sudden increase prevention angle per unit time from the actual steering angle at the time point at which the lane boundaries become recognizable.

3. A vehicle driving assistance method of executing steering assistance control of applying steering assistance torque to steering operation to be performed by an operator of an own driver to assist the steering operation, the steering assistance torque acting against the steering operation,
the vehicle driving assistance method comprising:
executing the steering assistance control when lane boundaries that are boundaries defining a lane on which the own vehicle is traveling is recognizable; and
stopping the steering assistance control when the lane boundaries become unrecognizable;
the steering assistance control being control of setting a limit steering angle based on a position of the own vehicle with respect to the lane boundaries and, when an actual steering angle of the own vehicle is larger than the limit steering angle, applying to the steering operation, the steering assistance torque at a value set based on a difference between the limit steering angle and the actual steering angle,
the vehicle driving assistance method further comprising executing sudden decrease prevention control when actually applied torque that is the steering assistance torque applied to the steering operation at a time point at which the lane boundaries become unrecognizable is larger than zero, and
the sudden decrease prevention control being control of decreasing the actually applied torque in steps of a predetermined sudden decrease prevention value per unit time from the actually applied torque at the time point at which the lane boundaries become unrecognizable or control of applying to the steering operation, the steering assistance torque set using as the limit steering angle, an angle that is increased in steps of a predetermined sudden decrease prevention angle per unit time from the limit steering angle set by the steering assistance control at the time point at which the lane boundaries become unrecognizable.

4. A non-transitory storage medium storing a vehicle driving assistance program of executing steering assistance control of applying steering assistance torque to steering operation to be performed by an operator of an own vehicle to assist the steering operation, the steering assistance torque acting against the steering operation,
the vehicle driving assistance program being configured to:
execute the steering assistance control when lane boundaries that are boundaries defining a lane on which the own vehicle is traveling are recognizable; and
stop the steering assistance control when the lane boundaries become unrecognizable,
the steering assistance control being control of setting a limit steering angle based on a position of the own vehicle with respect to the lane boundaries and, when an actual steering angle of the own vehicle is larger than the limit steering angle, applying to the steering operation, the steering assistance torque at a value set based on a difference between the limit steering angle and the actual steering angle,
the vehicle driving assistance program being configured to execute sudden decrease prevention control when actually applied torque that is the steering assistance torque applied to the steering operation at a time point at which the lane boundaries become unrecognizable is larger than zero, and
the sudden decrease prevention control being control of decreasing the actually applied torque in steps of a predetermined sudden decrease prevention value per unit time from the actually applied torque at the time point at which the lane boundaries become unrecognizable or control of applying to the steering operation, the steering assistance torque set using as the limit steering angle, an angle that is increased in steps of a predetermined sudden decrease prevention angle per unit time from the limit steering angle set by the steering assistance control at the time point at which the lane boundaries become unrecognizable.
